(19) United States
(12) Patent Application Publication
(10) Pub. No.: US 2026/0227650 A1
(43) Pub. Date: Aug. 6, 2026

(54) Device and Method for Myopia Control

(71) Applicant: Mauro Stabile, Miami, FL (US)

(72) Inventor: Mauro Stabile, Miami, FL (US)

(21) Appl. No.: 19/149,841

(22) PCT Filed: Feb. 2, 2024
(86) PCT No.: PCT/US2024/014329

§ 371 Date: Jul. 21, 2025

Related U.S. Application Data
(60) Provisional application No. 63/443,007, filed on Feb. 2, 2023.

(51) Int. Cl. G02C 7/06

(52) U.S. Cl. CPC G02C 7/06

(57) ABSTRACT

A treatment method and device for myopia is provided which includes a film substrate having a central zone preferably having a neutral spherical aberration therethrough. Surrounding the central zone on the film substrate is a peripheral zone having a partial or a total hypermetropic defocus therein. The film substrates are removably adherable to the existing lenses of eyeglasses worn by a user.

This application claims priority to U.S. Provisional Patent Application Ser. No. 63/443,007 filed on Feb. 2, 2023.

### BACKGROUND OF THE INVENTION

### 1. Field of the Invention

The invention herein disclosed relates generally to myopia. More particularly, it relates to a device and system employing removably engageable film layers configured for positioning upon eyeglass lenses.

### 2. Prior Art

### Background of the Invention

Near-sightedness, also known as myopia, is an eye condition where light focuses to a area in front of the retina instead of upon the retina of the eye. Consequently, for a person having myopia, distant objects appear blurry, while objects in close proximity to the eye will appear substantially clear or normal. Severe myopia or near-sightedness has become associated with an increased risk of retinal detachment, cataracts, and glaucoma for the person suffering from such.

It has been found that an underlying cause of myopia stems from the length of the eyeball growing too long. This in turn causes the focal point of the lens to project incoming light to the area in front of the retina. While a genetic predisposition to develop myopia is one cause, modern research has found evidence which indicates that a risk of near-sightedness is significantly increased when children are indoors a majority of the day and are frequent users of computers having screens.

Conventionally, the vision distortion to a patient from myopia or near-sightedness can be corrected with eyeglasses, contact lenses, or a refractive surgery. The employment of eyeglasses is an easy and safe manner for providing vision correction for those suffering from myopia. This is especially in children.

Contact lenses can provide a wider field of corrected vision to those with myopia but are not generally well received by children. For older myopia patients, refractive surgery can provide relief. However, such surgery also permanently changes the shape of the cornea. All in all, uncorrected near-sightedness is one of the most common causes of vision impairment for patients globally.

While, as noted, vision distortion of myopic vision is correctable using eyeglasses, contact lenses or refractive surgery, because of the increasing prevalence of myopia with young persons, the potential for lifelong sight problems has become ever more worrisome. As a consequence, treatments attempting to control and or halt the progression of myopia for patients at young ages have been developed.

To date, such treatment for myopia in youth has focused upon the use of permanent lenses or contact lenses. Such lens use tends, however, to impair the peripheral image quality of the perceived vision of the user. Conventionally, such is accomplished through the employment of permanently formed lenses which are operatively positioned in or on an eyeglass frame. Such conventional corrective devices generally have an 8-11 mm central viewing area which is surrounded by a defocused peripheral area.

However, such conventional treatment devices are provided and worn as a separate piece of eyewear from that normally worn by the patient. As a consequence, such permanent lenses cannot be changed as to central zone and peripheral area, or removed, or relocated should use on a patient require it.

With respect to the above, before explaining at least one preferred embodiment of the device and system herein for treatment and control of myopia, it is to be understood that the system herein is not limited in its application to the details of employment and to the arrangement of the adhering film components or the steps set forth in the following description or illustrated in the drawings. The various adherable film components providing for visual defocus in a peripheral zone which surrounds a central zone having a neutral dioptic power, are capable of other embodiments, and of being practiced and carried out in various similar ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other lens adhering systems for the provision of myopia control for children and adults. It is important, therefore, that the embodiments, objects and claims herein, be regarded as including such equivalent construction and methodology insofar as they do not depart from the spirit and scope of the present invention.

### SUMMARY OF THE INVENTION

The disclosed system herein provides a device and method which is employable by users to treat myopia by the positioning thereof upon their existing eyewear, such as eyeglasses. So positioned the disclosed device provides both a lens alteration and method for an optical or vision treatment to one or both eyes of the user, to treat, help control and to substantially halt the progression of myopia. The device and method herein is especially helpful for such in young patients.

The device herein employed in the manner herein, features one or a plurality of film substrate components and assemblies, which are configured to achieve an easily removable engagement directly to the surfaces of the lenses of new or existing eyeglasses. It, therefor, alleviates the need for specialized eyewear and frames and the like, separate from the eyewear worn by the user.

In all modes of the device and system herein, the film substrate, in a method employed to treat myopia, is easily removably engageable to either of the two surfaces of one or both lenses of existing eyewear, such as eyeglasses. The substrate portion so applied includes a central zone surrounded by a peripheral zone.

The central zone of the film substrate preferably has a neutral spherical power when the substrate is adhered to an eyeglass lens and viewed therethrough. The peripheral zone in the area surrounding the central zone includes a partial or total hypermetropic defocus either over its entire surface area or a major portion thereof such that the user has a clear view through the central zone and a distorted view through the peripheral zone. By hypermetropic defocus herein is meant forming the peripheral zone on or as part of the body of the film substrate to deliberately introduce out-of-focus images on the peripheral retina while maintaining clear vision on the central retina.

By film substrate herein means any polymeric or plastic or other material which can be formed to the shape of the body of the substrate herein and can be configured for removable engagement of the film substrate to the surface of an eyeglass lens and removed after use. The thickness of the film substrate may be such that it easily bends and conforms to one surface of an existing eyeglass lens, or it may be substantially rigid and have a surface shape which conforms to the surface of the eyeglass lens to which it will engage.

By removable engagement is meant electrostatic attraction, releasable adhesive, or any other adherence property or material allowing the body of the film substrate to form a fixed or non sliding positioned contact and positioning upon an eyeglass lens which can be easily removed by pulling or sliding it from such fixed contact.

Currently, such a removable engagement may be accomplished by forming the adherable film component from a substrate which is intentionally statically charged. Such a structural attachable component allows the film substrate to be attracted to and cling to a surface of a glass, plastic, or other polymeric lens, such as those conventionally mounted in eyeglasses. This electrostatic engagement will hold the body of the film substrate in a fixed position until removed thereby insuring that the central zone through which the user views, is fixed in position during use.

Disengagement of the provided one or plurality of substrates is as simple as the engagement. The film substrate of the device herein may be easily pulled from a removable engagement to the surface of an eyeglass or spectacle lens using provided projecting tabs. A removably engageable optically correct adhesive may also be employed. However, the electrostatic charged means for removable engagement is preferable as it leaves little or no smudges, marks, or material on the surface of the eyeglass lens which would require cleaning. Where the film substrate is of a thickness or material rendering it substantially fixed in shape, magnets might be employed. However, the method of use of the device herein is for adherence to existing eyeglasses or eyewear of the user and electrostatic or removable adhesive is preferable.

When the film substrate forming the device is removably engaged to a surface of a spectacle lens, the film substrate or component is configured to alter the image quality viewed by the user through that lens in a view-altered or a peripheral zone area. This peripheral zone preferably completely surrounds a central zone or viewing area.

The central zone or viewing area is configured to provide the user with a clear or neutral optical power view therethrough. Currently, the film substrate is formed of polymeric material with a substantially circular shape and having a diameter between opposing perimeter edges of 20-60 mm with a diameter of 25-35 mm being particularly preferred as such has been found in experimentation to fit easily upon a wide variety of existing lenses of the eyewear already worn by users.

Each film substrate within a rounded rectangular or generally oval or circular perimeter defining the shape thereof, as noted, has a central zone or viewing area. However, for eyewear lenses having a more rectangular shape, the perimeter of the body defining the polymeric film substrates may be more rectangular.

As noted, the central zone or viewing area is formed to have a neutral dioptic power therein. The formation of this neutral dioptic power may be accomplished by having an opening communicating through the body of the film substrate where the material forming it within the central zone is removed. The central zone may also have the film substrate within the central zone formed of the polymeric or other material which is optically correct in a fashion to yield no visual correction.

In some modes of the device herein, for use with patients having high power corrective lenses, the central zone may be formed with a visual correction therein which combines with the power of the lens to which it attaches to yield a neutral dioptic power within the central zone. Currently, an area between 6-16 mm is preferred with an 8-10 mm viewing zone being particularly preferred as such as been shown in development of the system to provide an ample area for viewing therethrough. While the central zone is depicted herein as substantially circular, other shapes, such as oval or rectangular are anticipated within the scope of the disclosed device and method herein.

As noted, on each film substrate a peripheral zone will surround the central zone and will be configured for visual defocus of this formed peripheral zone. Currently, formation of the area of the body of the polymeric film substrate, forming this peripheral zone, have between a 1.0 to 4.5 diopter, has been found in experimentation to yield the preferred visual defocus area. Particularly preferred is a 3-5 diopter when viewed through the peripheral zone to provide the required visual defocus for the user viewing through the central zone.

This defocusing can be formed by varying the thickness or curve of the peripheral zone or varying the clarity of the material forming the body of the film substrate in the area of the body peripheral zone, or engraving or etching the material forming the body of the film substrate in the peripheral zone, or by using other means as would occur to those skilled in the art to impart the desired visual defocus of the desired diopter. Defocusing might also be achieved by forming fresnel type lenses in the peripheral zone or blurred material or printed or quantum dots in the material forming the body of the peripheral zone.

In addition to forming the film material forming the body of the film substrate yielding this peripheral zone with a diopter defocus, the peripheral zone can also provide this defocusing by the inclusion of a tint or applied image or other surface providing alteration to the film forming the film substrate to form the defocusing and contrast of images viewed through this peripheral area. As such, by defocusing in the peripheral zone herein is meant any material or surface or visual detriment formed onto or into the body of the film substrate within the peripheral area which will yield a visual defocus which surrounds the optically correct or neutral central zone.

In an especially preferred mode of the device and system herein, the film substrate preferably includes a covering film layer engaged with the film substrate to form an assembly. Preferably, the covering film layer includes centering indicia thereon, such as a centering target or centration cross thereon. This centration cross or centering target is removable from a position located substantially in the center of the viewing area with the covering film is adhered. The centering target allows the film substrate be precisely located for treatment of the user such as adjustments for two film substrates mounted on respective eyeglass lenses to achieve a desired or necessary pupillary distance (PD) for the eyes of the user.

With this indicia, such as a centration cross, the user may employ a mirror or the help of a second person viewing such a centering target to properly position the film substrates of the device herein on the two lenses of existing eyeglasses. Once so achieved, the centering target is removed by detachment of a secondary film layer bearing the centering target. The secondary film layer may be removably engaged to one side of the film substrate of the device herein in the same fashion as the film substrate removably engages to a surface of an eyeglass lenses.

Additionally, the device and system herein can be provided as a kit or group including multiple film substrates. In such a kit configuration, each provided film substrate may have a differently sized central zone and/or differently sized peripheral zone. Further, the amount or diopter of the peripheral zones of respective film substrates in such a kit can also include such peripheral zones having a smaller positive diopter or larger positive diopter thereby affecting the view of the wearer therethrough. Provided in this kit fashion, a device formed with a film substrate having the properly configured central zone and peripheral zone can be chosen for use from the group which is customized to the needs of a patient.

With respect to the above description, before explaining at least one preferred embodiment of the device and system or treatment and control of myopia in patients, it is to be understood that the invention is not limited in its application to the details of operation nor the arrangement of the components or the steps set forth in the following description or illustrations in the drawings. The various methods of implementation and operation of the myopia treatment and control system and method herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of removably engageable films or layers and the like which can be positioned upon and removed from the original or existing corrective lens of the user for treatment.

As such, the objects and claims herein should be regarded as including such equivalent construction, steps, and methodology insofar as they do not depart from the spirit and scope of the present invention.

It is a primary object of this invention to provide film substrates configured to removably engage to the exterior surface of existing eyewear lenses, where the substrates consist of a central zone having a neutral or other spherical power and a peripheral zone formed around the central zone having a partial or total hypermetropic defocus either over the entire surrounding surface or a portion of it.

It is another primary object of this invention to provide a method of treating myopia using adherable substrates which can be mounted and easily dismounted upon the lenses of existing eyewear of the patient with myopia.

It is an object of this invention to provide a film substrate or layer which is removably engageable to existing eyeglass lenses of the user to provide myopia control and treatment while removably engaged to such lenses and to thereby alleviate the need for multiple pairs of eyeglasses.

It is a further object of this invention to provide such removably engageable film substrates for myopia control in a kit or collection of different designs as to the central viewing area and surrounding defocused peripheral areas to thereby allow the user or vision professional to choose and employ the film substrate best adapted to control and treat myopia of each respective patient.

It is a further object of this invention to provide such a removably engageable film substrate for myopia treatment and control which includes a center target or centration cross which can be employed to precisely locate and adjust each film substrate, as necessary, for each individual user.

These, together with other objects and advantages, which become subsequently apparent reside in the details of the construction and operation of the room airflow assessment and redesign system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed film substrate device and system herein for treatment and control of myopia. It is intended that the embodiments and figures herein are to be considered illustrative of the method and device for myopia control and treatment herein, rather than limiting.

In the drawings:

FIG. 1 shows the device herein in an as-used positioning or mode of the film substrate forming the device for the system herein, wherein one film substrate is shown operatively engaged in a removable engagement to a surface of a first lens of eyeglasses and a second film substrate is shown being positioned prior to removal of a secondary layer or substrate.

FIG. 2 depicts a film substrate of the device herein showing the assembly of a body of the film substrate and removably covering film layer showing a center target positioned upon the covering film layer which, in sequential images, is shown being removed from the substrate by force imparted to a pull tab.

FIG. 3 depicts the body of the film substrate of FIGS. 1-2 herein removably positioned on the front surface of the lenses mounted in an eyeglass frame opposite a rear surface thereof closest to the eyes of the wearer.

FIG. 4 shows the film substrate of FIGS. 1-2 herein wherein the film substrate device is removably engaged to the rear surface of the lenses mounted in an eyeglass frame.

FIG. 5 shows a mode of the film substrate device herein wherein an assembly having the film substrate is provided with a covering film layer having a pull tab with indicia thereon such as number 1, which protects the mounting surface of the film substrate prior to its removable engagement to a surface of a lens and shows the secondary film layer having pull tab number 2 which may be removed once the substrate device is operatively engaged with one surface of a lens.

FIG. 6 depicts the film substrate device herein which may be provided in a kit or group of film substrates where the size of the central zone and/or the amount of defocusing of the peripheral area may be varied.

FIG. 7 shows the film substrates ready for mounting to an eyeglass lens provided upon a paper or similar mount wherein they may be peeled therefrom and operatively mounted on the eyeglass lens.

FIG. 8 shows some examples of the multiple configurations where the defocusing of the peripheral zone surrounding the central may be formed.

### DETAILED DESCRIPTION OF THE PREFERRED EMBODIMENTS OF THE INVENTION

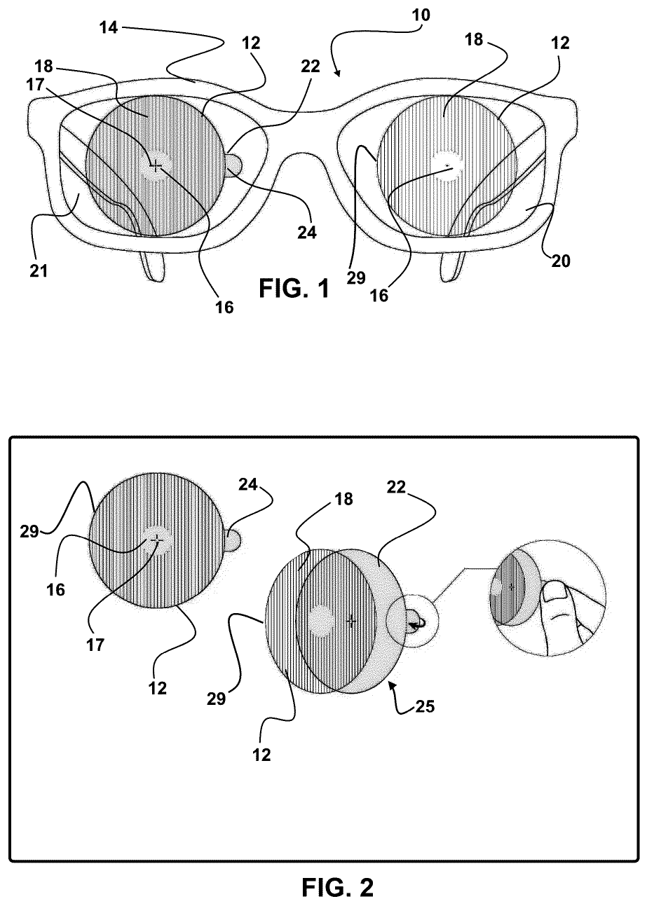

Referring now to the film substrate device 10 and method herein, shown depicted in FIGS. 1-8, there is seen in FIG. 1, the system 10 herein in an as-used mode wherein film substrates 12 are removably engaged to eyewear 14.

In all preferred modes of the system 10, the film substrates 12 include a central zone 16 preferably having a neutral spherical aberration or spherical power therethrough once it is removably engaged to a lens 20 or 21. While the system 10 can employ a central zone 16 which has a positive or negative spherical power therethrough, when applied to the eyewear of the user, a neutral spherical power, when engaged to the lens 20 or 21, allows for the broadest and easiest use by patients or wearers of the eyewear since the spherical power of the lens 20 or 21 need not be a factor.

In all modes of the system 10, the film substrates 12 also include a peripheral zone 18 formed around the central zone 16 which are formed with a partial or a total hypermetropic defocus therein which preferably covers over the entire surrounding surface area of the peripheral zone 18 while in some cases may cover a part of it.

The film substrates 12, in the preferred modes of the system 10 herein, are configured to form a removable engagement to the surfaces of one or both lenses 20 and 21 of eyewear 14, such as eyeglasses or goggles or similar eyewear worn by a wearer or patient or user. This allows the system 10 and the film substrates 12 to engage with virtually any eyewear lens to which it will removably engage, such as the normal eyewear worn by a user without the film substrates 12.

While not shown, the system 10 herein may also be used with a curved shield-style lens, such as employed with safety glasses and sunglasses and the like. Where a curved shield-style lens is used, the film substrate 12, while not shown as such, may be formed in a single piece having two central zones 16 surrounded by a peripheral zone 18. However, the pupil spacing would be a challenge for this configuration unless the wearer is measured for such in advance and the central zones 16 placed to match the measurement.

As depicted in FIG. 1, a first or film substrate 12 is depicted in such a removable engagement to a first lense 20. An adherable side 29 forms the removable attachment upon the first lens 20. As noted, the system 10 can simply include this first film substrate 12 which would be applied to one or both lenses 20 and 21 of the eyewear.

As also shown in FIG. 1, a second of the film substrates 12, configured the same as the first, is positioned on a second lens 21. As shown in this preferred mode, the second of the film substrates 12 is configured having a covering film layer 22 which includes a grippable projection, such as a tab portion 24. The tab portion 24, as shown in a preferred mode, projects from the perimeter edge of the film layer 22 and thereby provides an easily gripped area for removal of the covering film layer 22 from the body of the film substrate 12 once it is removably engaged to a lens. The projection can be formed in other modes so long as it projects away from a surface or edge of the film layer 22 and is easily pulled by a user to separate the film layer 22 from the body of the film substrate 12.

Once the adherence side 29 of the film substrate 12 is removably engaged to the lens 21, the film layer 22 can be easily pulled from its removable engagement to the opposite side of the film substrate 12. The removable engagement, much like that of the film substrate 12 of the film layer 22, may be by electrostatic attraction or adhesive in a fashion allowing it to be pulled from the film substrate 12 without dislodging it from the lens 20 or 21.

During development of the system 10, forming a projection, shown as the tab 24, extending from the perimeter of the film layer 22 proved to provide the easiest positioning for the film substrate 12 since the user could easily watch the target 17 (FIG. 1) in the central zone 16 while concurrently holding the eyewear. The projection or tab 24 formed in this manner is also more easily formed a unitary structure and part of the body of the film layer 22.

The projection or tab 24 also allows the user to accurately position the film substrate 12 to a proper location on the lens 20 or 21 without having to touch the film substrate 12 itself or the lens 20 or 21 on which it is to be engaged. This is preferred for ease of use and to avoid fingerprints and smudges upon the film substrate 12. While shown as a projection extending from the perimeter edge of the film layer 22, it is envisioned the tab 24 or a similar grippable projection may extend from a rear surface of the film layer 22 and provide for gripping and removal.

It should be again noted that the film substrate 12 could be provided without the covering film layer 22, such as having the film substrate 12 positioned on quick release paper or the like where the user could remove it and place it upon a chosen first lens 20 or second lens 21. While this will allow the wearer to use the system 10 herein, as noted it is prone to fingerprints and smudges upon the film substrate 12 from the fingers of the person positioning it.

Consequently, while the system 10 herein can be used with film substrates 12 having no covering film layer 22, the inclusion of such significantly reduces any incidence of smudges and fingerprints on the film substrate 12 and makes it much easier to hold and mount the film substrate 12 while engaged with a film layer 22. Also, while a projectio, n such as the depicted tab 24, could extend from the body of the film substrate 12 and allow the user a manner to grip and position the film substrate 12, the user will still need to touch a surface of the film substrate 12 to push it against the lens 20 or 21, which can cause fingerprints. Consequently, the system 10 herein may employ a mode with just the film substrate 12, and such is envisioned. The inclusion of the film layer 22 with a projection, such as a tab 24 thereon, is superior.

Shown in FIG. 2 is a sequence showing a film substrate 12 of the system 10 in an assembly 25 in a removable engagement with the covering film layer 22, which is initially engaged being removed in the shown sequence. In some modes of the system 10, there may be a single covering film layer 22 and, as noted herein, in others there may be additional secondary covering layers which engage upon the adherable side 29 of the film substrate 12.

As noted, in all modes of the system 10, the planar body of each film substrate 12 includes a central zone 16 having a preferably neutral or other spherical power therethrough. This film substrate 12 is formed with a peripheral zone 18 which is treated to have a partial or total hypermetropic defocus therein which covers over the entire surrounding surface area of the peripheral zone 18 or a major part of it.

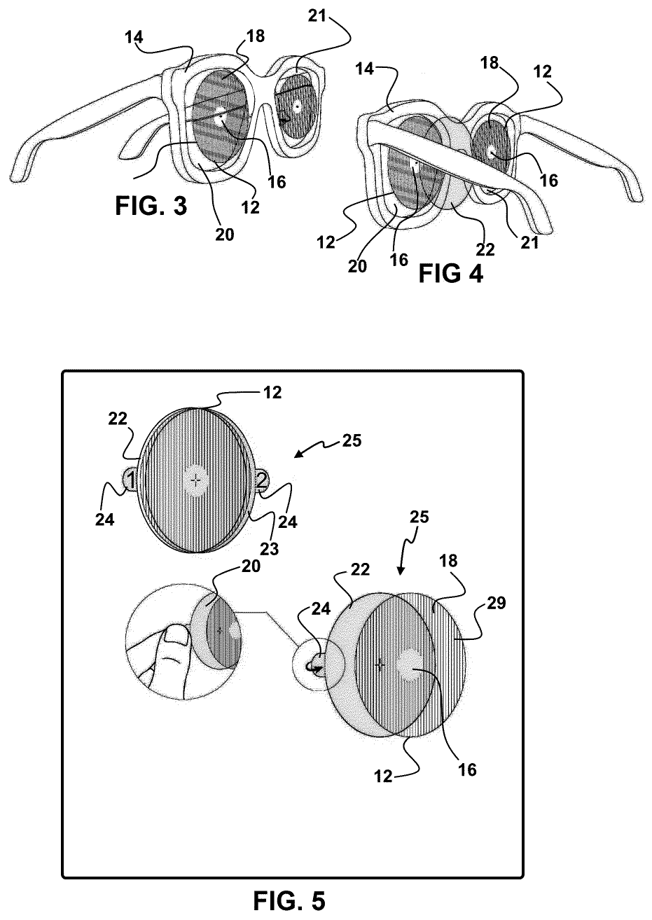

As shown in FIG. 3, the film substrates 12 have been removably positioned upon the front or exterior side of the lenses 20 which is the side of the lenses 20 opposite that which faces the eyes of the user. With the eyewear 14 positioned on their head, the opposite or interior side is closest to the user and is shown in FIG. 3.

FIG. 4 depicts the body of the film substrate 12 of FIGS. 1-2 and shows the mounting thereof wherein one film substrate 12 has been removably engaged by the adherable side 29 to the rear of the lenses 20 mounted on eyewear 14, such as an eyeglass frame. Also shown is a film covering layer 22 being pulled from the opposite side of the film substrate 12 from the adherable side 29 (FIG. 5) once it is has been removably engaged to a lens 20.

As noted, this removable engagement may be accomplished with optically correct adhesive positioned on a contact surface of the film substrate 12, or with an electrostatic engagement of the film substrate 12 to a lens 20 or 21, with or other means for removable engagement of the film substrate 12 to a lens 20 or 21.

Shown in FIG. 5 is a mode of the film substrate 12 herein, wherein the planar body of the film substrate 12 is provided with a first covering film layer 22 having a projection in the form of a pull tab 24 which protects the mounting surface or adherable side 29 of the film substrate 12 prior to removable engagement to a lens 20.

Also shown in FIG. 5 are a secondary covering film layer 23 having a projection provided by the pull tab 24 having the indicia thereon indicating a position for removal in a sequence, such as the numeral 2. This positions the film substrate 12 in a sandwiched positioning between the covering film layer 22 and the secondary covering film layer 23. The projection formed by the tab 24 and the secondary covering film layer 23, having this indicia, is removed sequentially once the mounting surface of the film substrate 12 is operatively engaged with a lens 20. Either the first covering film layer 22 or the secondary covering film layer 23 may be formed of other material, such as paper, so long as it easily disengages from the film substrate 12 in the assembly 25 shown in FIG. 5.

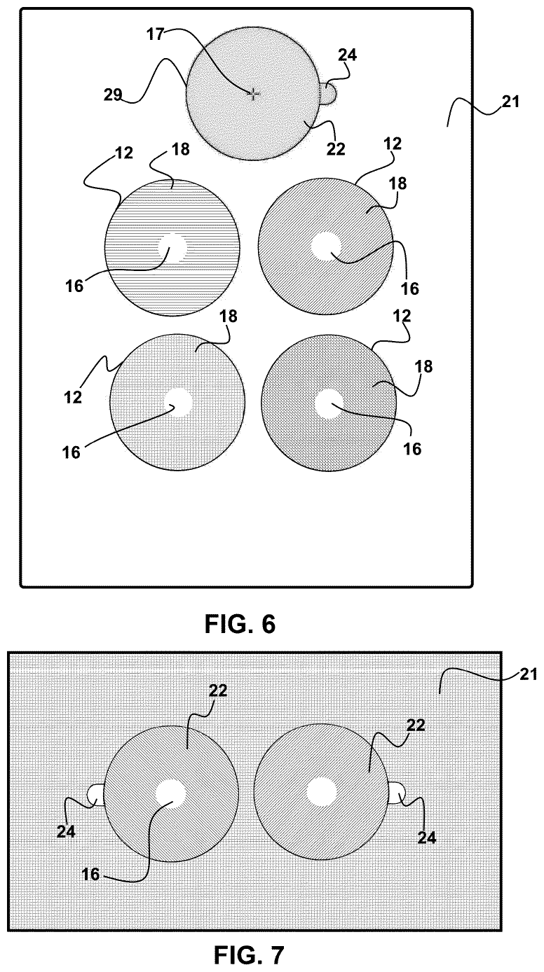

Shown in FIG. 6 is a manner of the system 10 herein, wherein the film substrates 12 may be provided in a group or kit of film substrates 12 removably engaged with a mount 21, such as a plastic or paper sheet. The depicted film layer 22 is shown adhered to one of the film substrates 12 in one area and for convenience is removed from the remainder of the shown film substrates 12. While the substrates 12 may be employed without the film layer 22 removably adhered to a side of the film substrate 12 opposite that which adheres to the eyewear lens, it is preferred to include it to allow use of the tab 24 and centering target 17 indicia, to hold and center the central area 16 before adherence to the eyeglass lens.

In the kit mode, the size of the central zone 16 and/or the amount of defocusing of the peripheral zone 18, and/or the total area of the peripheral zone 18 surrounding the central zone 16, may be varied, as needed. Such would allow for differently configured film substrates 12 to be provided which can be used to treat differing vision issues or varying levels of near sightedness of the user patient.

In all modes of the system 10 herein, the film substrates 12 are configured to be employed in the method for treating myopia. In the method, for a patient being treated for myopia, such as subsequent to vision tests to determine their visual issues, in a first step, in the simplest configuration, a film substrate 12 will be removed from a mount attached to an adherable side 29 thereof. In a next step, an adherable side 29 of the film substrate will removably adhere to at least one or to both eyeglass lenses of the eyewear of the patient user. The user will be allowed to wear the eyeglasses with the film substrate 12, so adhered, for the duration of treatment. At the end of the treatment session the film substrate 12 will be removed from the eyeglass lenses.

In optional but preferred steps, to accurately position the central zone 16 of the film substrate 12 in an alignment with the pupil of the user when wearing the eyewear to which the film substrate is attached, a covering film layer 22 is removably adhered to the side of the film substrate 12 opposite the adherable side 29 thereof. Centering indicia positioned on the covering film layer 22 which is substantially centered within the central zone 16 of the film substrate 12 is aligned with the pupil of the user wearing the eyewear. Thereafter, the film covering layer 22 is removed. Once the treatment is completed the film substrate 12 is removed. Optionally but preferred, a projection or tab 24 extending from the covering layer 22 is held during the centering and placement of the film substrate 12.

Using the kit of FIG. 6, the proper film substrate 12 from the kit having differing values of defocusing in the peripheral zones 18, may be chosen for use with the eyewear of the patient or user to treat the determined visual issue. Should the vision of the user change over time, differing members of the kit of film substrates 12 configured to treat the changed vision of the user or patient can be chosen and employed.

In a mode of the method and device employable by remote communication, the film substrates 12 can be formed locally to the size of the central zone 16 needed for a patient and/or the amount and type of defocusing, positioned in the peripheral zone 18. Thereafter, in the method the system 10 provides for the formation of the film substrates 12 by printing locally using lasers printers or the like configured to print upon film substrates 12 formed on a mount 21 sheet adapted for employment in the printer.

In this fashion, where the configuration needs of the film substrates 12, needed for a patient or other user, are determined in a vision test, the film substrates 12 may be formed by printing them with the peripheral area with a laser, inkjet, heat activated, or other printer.

A printed pattern forming this peripheral zone 18 with the required partial or total hypermetropic defocus can be imparted to the body of film forming the film substrate 12. This mode of the system 10 allows for the instant production of the required film substrates 12 with the appropriate sized central zone 16 and the correct characteristics of the customization of the peripheral zone 18 as to a partial or total hypermetropic defocus therein and the area covered in the peripheral zone.

For example and in no way limiting, a sheet of material having the film substrates 12 formed in a frangible fashion allows for printing upon the film substrate area of the sheet. Thereafter, the customized film substrates 12 may be removed from the sheet using the frangible lines formed around their respective perimeters.

In FIG. 7 is shown another manner for forming and tendering the device of the system 10 herein to users. The assembly 25 of the film substrate 12 will be engaged to the film covering 22 having the projection 24 on the non-adherable side of the film substrate 12. The assembly 25 is removably engaged to the mount 21, such as a sheet of paper or plastic or the like, by removable engagement of the adherable side 29 of the film substrate 12 to the mount 21. In use in the method herein, the assembly 25 formed by the film substrate 12 removably engaged with the film covering 22 is pulled from the mount 24, preferably with the projection 24. Thereafter, holding the projection 24 the central zone 16 is aligned with the pupil of the eye of the user wearing the eyeglasses, and the adherable side 29 of the film substrate 12 is attached to the lens of the eyewear.

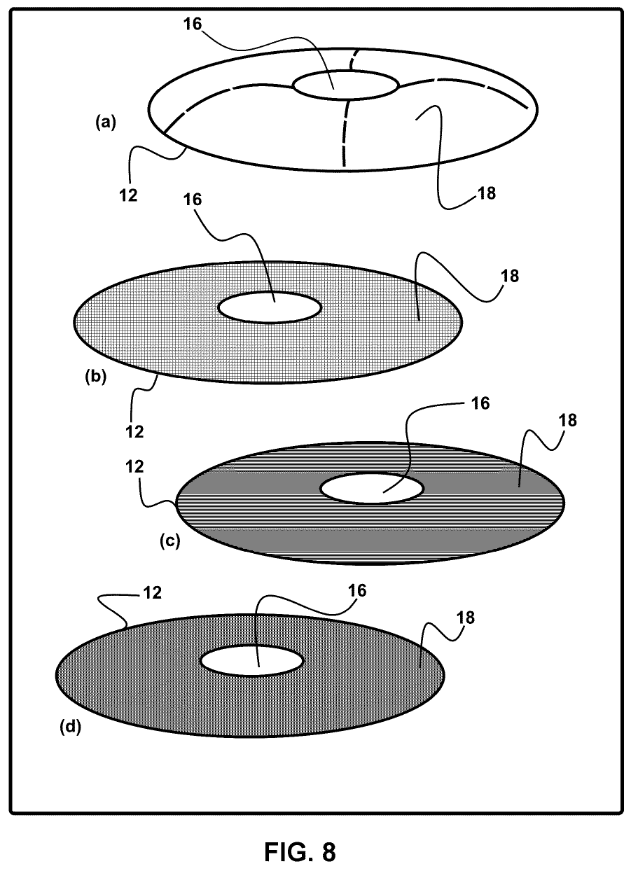

In FIG. 8 is depicted some examples of the multiple configurations where the defocusing of the peripheral zone surrounding the central may be formed by different means. Show as (a) in FIG. 8, the peripheral zone 18 is formed by curing the non adherable side of the body of the film substrate 12. Shown in (b) of FIG. 8, the peripheral zone 18 is formed by imparting a fresnel pattern therein. Shown in (c) of FIG. 8, the peripheral zone defocusing is formed by blurring the material of the body of the film substrate 12 in the peripheral zone 18. Finally, shown in (d) of FIG. 8, the defocusing in the peripheral zone 18 is formed by printing or engraving a pattern to the body of the film substrate 12 only in the peripheral zone 18. In all the modes shown in FIG. 8, the central zone 16 is formed by either forming a void by removing the material of the body of the film substrate 12 therein, or by employing a configuration of the material which yields a neutral effect on the optics therethrough.

While all of the fundamental characteristics and features of the method and device herein to provide an optical treatment to control and halt the progression of myopia in patients have been shown and described herein, with reference to particular embodiments thereof, a latitude of modification, various changes and substitutions are intended in the foregoing disclosure and it will be apparent that in some instances, some features or steps of the disclosed system may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention herein disclosed.

What is claimed is:

1. An apparatus for treatment of myopia, comprising:
a film substrate having an adherence side and a second side opposite said adherence side;
a central zone of said film substrate surrounded by a peripheral zone;
said film substrate positional in a removable engagement of said adherence side to an eyeglass lens to an as-used positioning thereon;
said central zone having a neutral spherical power when viewed therethrough; and
said peripheral zone formed with a hypermetropic defocus when viewed therethrough, wherein said film substrate positioned to said as-used positioning provides defocused vision through said peripheral zone.

2. A method of treatment for myopia employing a film substrate having an adherence side and a second side opposite said adherence side, and a central zone of said film substrate surrounded by a peripheral zone, comprising:
attaching said adherence side of said film substrate to an eyeglass lens of the eyeglasses of a user;
having the user view through the central zone while said film substrate is attached to the eyeglass lens during a treatment session for myopia; and
removing said film substrate from said eyeglass lens upon cessation of said treatment session.

3. The apparatus for treatment of myopia of claim 1 additionally comprising:
a film covering removably engaged to said second side of said film substrate;
a projection extending from said film covering;
said projection for holding by a user while positioning said adherence side of said film substrate to said removable engagement; and
said film substrate removable subsequent to achievement of said removable engagement of said adherence side of said film substrate.

4. The apparatus for treatment of myopia of claim 3 additionally comprising:
centering indicia positioned upon said film covering;
said centering indicia being substantially centered within said central zone while said film covering is removably engaged to said second side of said film substrate;
said centering indicia defining a target for alignment thereof with a pupil of said user during positioning said film substrate to said removable engagement.

5. A method of treatment for myopia employing the apparatus, as in claim 4, comprising the steps of:
holding said projection while said film covering is removably engaged to said second side of said film substrate;
aligning said targeting indicia with the pupil of one eye of a user positioned upon an interior side of said eyeglass lens;
positioning said film substrate to said removable engagement with said eyeglass lens with said targeting indicia aligned with said pupil; and
removing said film covering;
having the user view through the central zone while said film substrate is attached to the eyeglass lens during a treatment session for myopia; and
removing said film substrate from said eyeglass lens upon cessation of said treatment session.
